(19) United States
(12) Patent Application Publication
(10) Pub. No.: US 2007/0174792 A1
(43) Pub. Date: Jul. 26, 2007

(54) Graphic subselection in a computer aided design

(76) Inventor: Richard D. Howard, Sausalito, CA (US)

Correspondence Address: FISH & RICHARDSON P.C., PO BOX 1022, MINNEAPOLIS, MN, 55440-1022, US

(21) Appl. No.: 11/340,784

(22) Filed: Jan. 25, 2006

(51) Int. Cl. G06F 3/00

(52) U.S. Cl. 715/866

(57) ABSTRACT

In one implementation, a computer-implemented method for graphical subselection is provided. The method includes presenting an image to a user. The image includes an original graphic selection set of graphical elements. The method also includes receiving a first user input identifying a first subselection of elements in the original graphic selection set. Additionally, the method includes visually differentiating the first subselection of elements in the image presented to the user. A second user input is received identifying a second subselection of elements in the original graphic selection set. The second subselection of elements is different from the first subselection of elements. Further, the method includes visually differentiating the second subselection of elements in the image presented to the user.

### TECHNICAL FIELD

The present specification relates to computer aided design.

### BACKGROUND

Conventional computer aided design (“CAD”) systems allow a user to design structures and devices that include a number of elements. Typically, CAD system components can include one or more stored object models representing standard structures such as windows, doors, or other mechanical or design objects, as well as maps and other graphical objects having a number of separate elements.

A display window can present graphical objects, which include a number of individual elements to a user. A user can create a selection set of elements from the presented graphical objects. Data describing parameters of the elements in the selection set can also be displayed.

### SUMMARY

In general, in one aspect, a computer-implemented method for graphical subselection is provided. The method includes presenting an image to a user. The image includes an original graphic selection set of graphical elements. The method also includes receiving a first user input identifying a first subselection of elements in the original graphic selection set. The first subselection of elements is visually differentiated in the image presented to the user. A second user input is received identifying a second subselection of elements in the original graphic selection set. The second subselection of elements is different from the first subselection of elements. Further, the method includes visually differentiating the second subselection of elements in the image presented to the user.

Implementations of the method can include one or more of the following features. Presenting an image to a user can include presenting an image to a user including a plurality of graphical elements and receiving a user input selecting the original graphic selection set of graphical elements. Receiving a user input selecting the original graphic selection set can include receiving a user input generating a selection region imposed on the image. The original graphic selection set can include substantially all of the graphical elements included within the selection region. Selecting the original graphic selection set of graphical elements can include selecting graphical elements from a plurality of layers in the image. Graphical elements belonging to a single class can be located in a single layer in the image. The selection of graphical elements from a plurality of layers can occur substantially simultaneously.

The method can further include visually differentiating the graphical elements of the first subselection of elements in the image. Visually differentiating can include highlighting the graphical elements of the first subselection of elements in the image. The method can further include displaying a data grid including data associated with the graphical elements included in the original graphic selection set of graphical elements. The first subselection of elements in the displayed data grid can be visually differentiated. Visually differentiating the first subselection of elements in the displayed data grid can include highlighting data included in the data grid that is associated with the elements included in the first subselection of elements. The second subselection of elements in the displayed data grid can be visually differentiated. Visually differentiating the second subselection of elements in the displayed data grid can include highlighting data included in the data grid that is associated with the elements included in the second subselection of elements.

The method can further include selecting a single element of the first subselection of elements and editing a value for a parameter associated with the selected element. An additional visual effect can be applied to identify the selected single element of the subselection of elements.

The first user input selecting a first subselection of elements can include selecting a particular class of elements from the original graphic selection set. Selecting a particular class of elements can include directly selecting an element of a particular class from the original graphic selection set of elements in the image. Selecting a particular class of elements can also include selecting a class from a menu.

In general, in another aspect, an apparatus for graphical subselection is provided. The apparatus includes a graphics engine configured to display an image, the image including a plurality of graphical elements. The apparatus also includes a selection engine configured to select an original graphic selection set of graphical elements. A sub-selection engine configured to select a subselection of elements in the original graphic selection set according to a received user input is also included. Additionally, the apparatus includes a display engine configured to display the image including the selected subselection of elements. The selection engine stores the original graphic selection set of graphical elements for use in subsequent element subselections.

Implementations of the apparatus can include one or more of the following features. The display engine can display data associated with the original graphic selection set in a data grid. The user can select a subselection of elements using the data grid. The data grid can be populated with data associated with the subselection of elements. The display engine can visually differentiate graphical elements in the displayed image to identify the original graphic selection set of graphical elements. The display engine can visually differentiate the graphical elements of the subselection in the displayed image to identify subselection of elements. The selection engine can be further configured to select an individual graphical element of the subselection of elements. The apparatus can further include an editing engine configured to modify data associated with a selected graphical element from the subselection of elements.

Implementations can provide one or more of the following advantages. A user can select a subselection of graphical elements from within a set of selected elements. The set of selected elements can include elements from more than one class of elements. The user can make a subselection of elements, in one example, according to element class within the set of selected elements. The user can then manipulate the subselection of elements including editing parameters of one or more elements of the subselection. The initial set of selected elements is retained so that the user can make other element subselections from the same selection set.

The set of selected elements and the subselection of elements can include visual indicators identifying the selections. The visual indicator can provide visual effects within the displayed elements, e.g., highlighting, to differentiate selected elements from unselected elements. The visual indicators allow the user to distinguish between a set of selected graphical elements, a subselection of graphical elements, and an individual actively selected graphical element in the graphical object.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates a block diagram of a graphical sub-selection system.

FIG. 2 illustrates a process for graphical subselection.

FIG. 3 illustrates a graphics window without a graphical selection.

FIG. 4 illustrates a selection region in the graphics window.

FIG. 5 illustrates a display of a selected set of elements.

FIG. 6 illustrates a sub-selection of elements.

FIG. 7 illustrates a selection of a particular element in the subselection of elements.

FIG. 8 illustrates a selection of a different element in the subselection of elements.

FIG. 9 illustrates a second sub-selection of elements.

FIG. 10 illustrates a selection of a particular element in the second subselection of elements.

FIG. 11 illustrates a transparent data grid.

Like reference symbols in the various drawings indicate like elements.

### DETAILED DESCRIPTION

Overview

A computer aided design (CAD) system providing user subselection of graphical elements is provided. One or more graphical objects including numerous graphical elements can be presented to a user. For example, a graphics window can display a constructed device, structure, map, or other graphical object. The user can select a set of elements from the presented graphical objects, for example, using a selection box. The selected set of elements, referred to herein as the “original graphic selection set”, can include all elements within a selection region including elements of different types or classes, or located in different graphical layers.

The user can then select a subselection of elements from the original graphic selection set of elements. The elements of a subselection can be visually differentiated to distinguish them (e.g., within the graphical object) from unselected elements. For example, the elements of the subselection can be highlighted, have a different color, or style. Individual elements of the subselection can be further selected. The user can edit one or more parameters associated with the subselection. The original graphic selection set is retained during the subselection process. Thus, the user can return to the original graphic selection set and select another subselection of elements from the selected set of elements.

Architecture

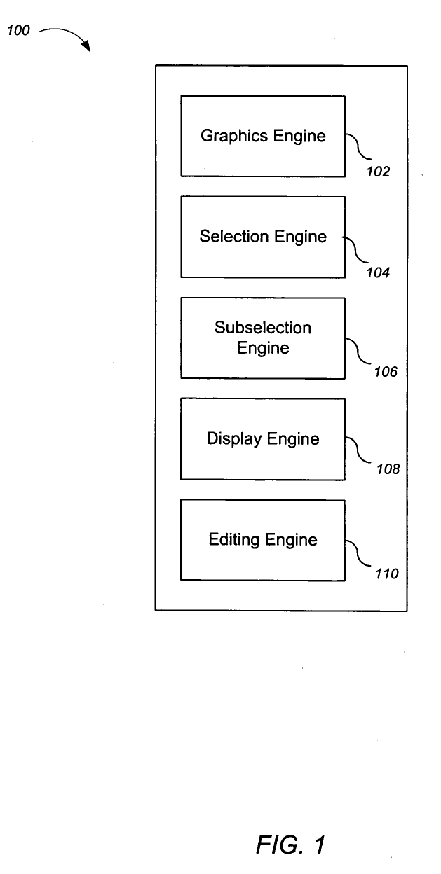

FIG. 1 shows one implementation of a system 100 for providing a graphical subselection of elements. The system 100 includes a graphics engine 102, a selection engine 104, a subselection engine 106, a display engine 108, and an editing engine 110. In one implementation, the system 100 can be implemented in whole or in part in a CAD software application, such as AutoCad® available from Autodesk, Inc., in San Rafael, California, or another CAD application or other software application with CAD functionality.

Referring again to FIG. 1, the graphics engine 102 can be configured to define graphical objects and the individual elements from which the graphical objects are composed. The graphics engine 102 can include parameters defining the attributes of each element as well as the element's relationship with other elements in a graphical object.

Element parameters can include, for example, the element's physical attributes including shape, size, and orientation. In one implementation, element parameters can also include other data associated with the element. For example, an element representing a parcel of land can include data identifying the parcel ID, owner, assessed value, and other data. The graphics engine 102 can store or retrieve graphical objects, for example using one or more databases, to be presented to the user.

The selection engine 104 can be configured to provide a user selection of graphical elements from a displayed graphical object. For example, a selection tool can be provided within a graphics window to demarcate a selection region within the displayed graphical object. The selection engine 104 can be configured to select the elements within the demarcated selection region and to provide parameter data associated with the selected elements to the user.

The selected graphical elements can be displayed both in the graphical display and in a data grid. The data grid can be a window identifying the selected elements and associated element parameters. The data grid can be a separate frame window from the graphical display or can be an overlay within the graphics window.

The subselection engine 106 can be configured to provide a user subselection of graphical elements from the user selection of graphical elements. For example, the user can identify subselected elements from the displayed graphics window. Alternatively, the user can select the subselection of graphical elements using the data grid displaying the selected graphical elements. In one implementation, the user can select a group of individual elements or a class of elements (e.g., a parcel, water line, or other element type). After creating a subselection, the user can select individual elements of the subselection, which can be indicated in both the graphical display of the graphics object and the data grid.

The display engine 108 can display the graphical objects to the user, for example, in a graphics window. The display engine 108 can include a rendering component for rendering the graphical data on a user display device. The display engine 108 can also display the selected (or subselected) elements of a graphical object, for example, by providing a visual effect differentiating the elements of a particular selection (e.g., by different colors, shading, or highlighting).

The editing engine 110 can provide for user edits of graphical elements in the subselection of elements. For example, the user can select a single element within the subselection of elements to edit. The user selection can be within the graphical display of the selected elements or within the displayed data grid. The user can edit one or more parameters associated with the selected element. The edited parameters of the element can be saved such that later use of the element includes the modified parameters.

Operation

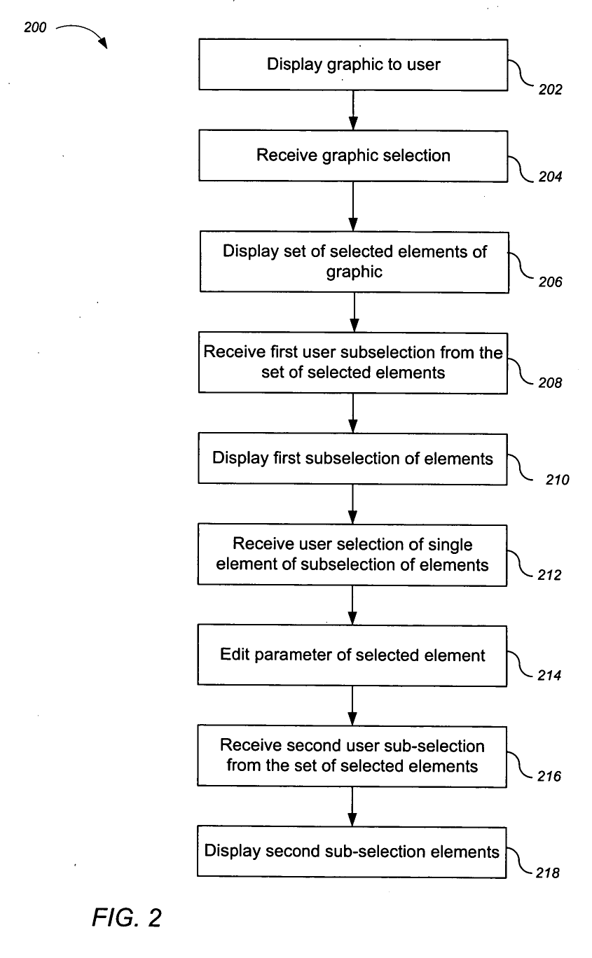

FIG. 2 shows one implementation of a process 200 for graphical subselection. Process 200 begins with the display of one or more graphical objects to the user as a displayed graphic (i.e., an image) (step 202), for example, in a graphics window of a CAD program. In one implementation, the user can select a particular graphical object or set of graphical objects to display through a menu selection. The selected graphical objects can be retrieved by a graphics engine (e.g., graphics engine 102) and rendered to a display device by a display engine (e.g., display engine 108).

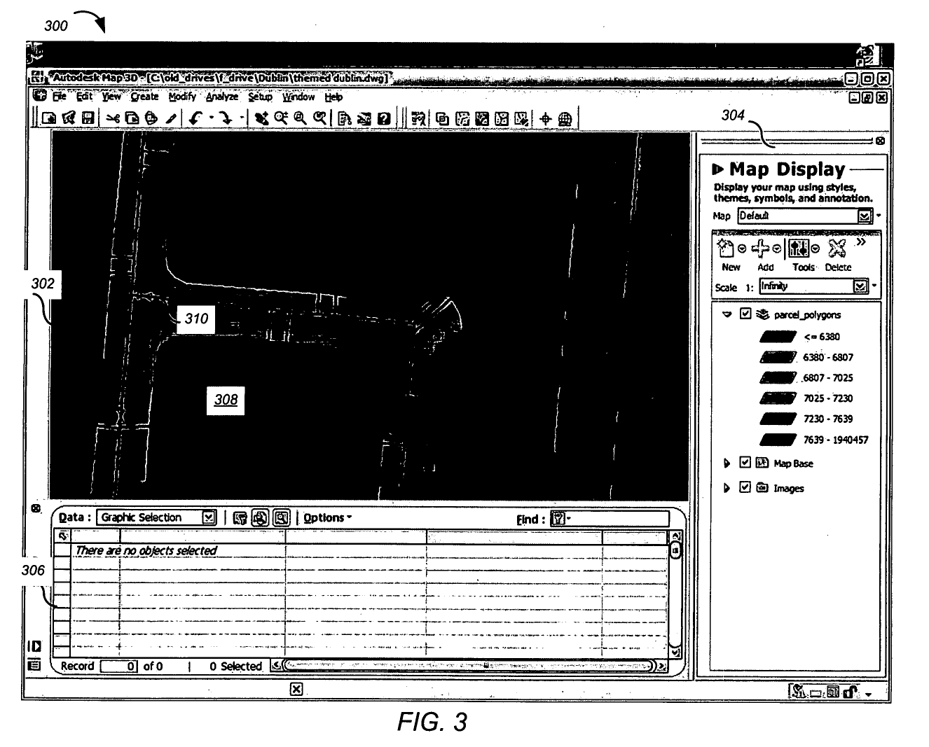

FIG. 3 shows a screenshot of a graphics window 300 displaying a graphical object. The graphical object, in this example, is a map object 302. The map object 302 includes different elements. For example, the map object 302 includes parcel elements 308 representing land parcels and utilities elements, such as water element 310 representing a water line. The graphical object can be selected, for example, using a selection menu 304. In one implementation, a data grid 306 is also provided in graphics window 300. The data grid 306 is shown as a separate frame in the graphics window 300. The data grid 306 is shown as empty in FIG. 3 because no selection of a set of graphical elements has been made from the map object 302.

A selection of an original graphic selection set of graphical elements within the displayed graphical objects is received (step 204). The user can make a selection, for example, using a selection tool. The user can use the selection tool to demarcate a region within the displayed graphical object(s). For example, the user can use an input device (e.g., a mouse) to drag a selection window within the window displaying the graphical object(s). A selection engine (e.g. selection engine 104) can select each element located within the demarcated region for inclusion in the original graphic selection set.

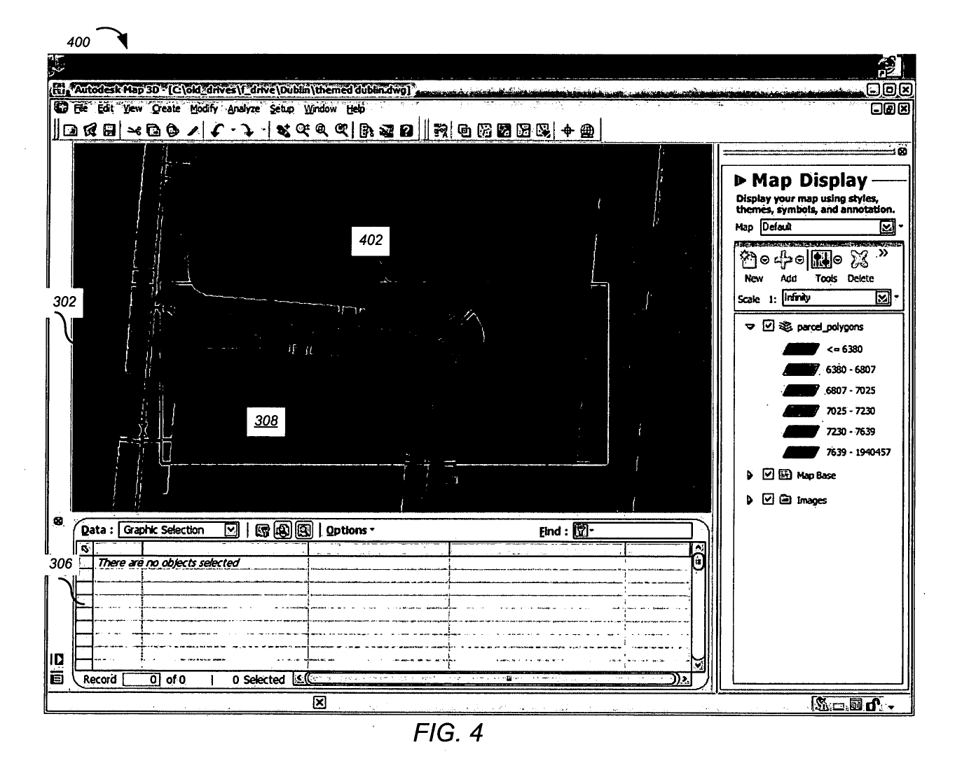

FIG. 4 shows a graphics window 400. Graphics window 400 includes the map object 302 in which a selection region 402 has been demarcated. The selection region 402 can be selected, for example, using a selection tool from toolbar 404. The selection region 402 is shown as a rectangular box. The size and shape of the selection region 402 can vary depending on the selection tool and user input. The size of the selection region 402 indicates the map elements, for example parcel 308, which are to be contained within the original graphic selection set of elements.

Elements can be included in different graphical layers in the graphical object. The selection region 402 can be used to select all the elements within the region, including elements located in different layers of the map object 302. For example, in creating the map object 302 the parcel elements (e.g., parcel 308) can be included in one layer and the utilities elements (e.g., water line 310) can be included in another layer of the map object 302. However, in one implementation, the selection region 402 can select elements from all layers in the map object 302 instead of only one layer (e.g., the top layer).

The original graphic selection set is displayed (step 206). The elements from the selection region can be displayed for the user in the graphics window. In one implementation, data associated with the selected elements can be displayed within a data grid. In another implementation, the selected elements can be illustrated within the map object, for example, by a visual differentiating effect such as highlighting.

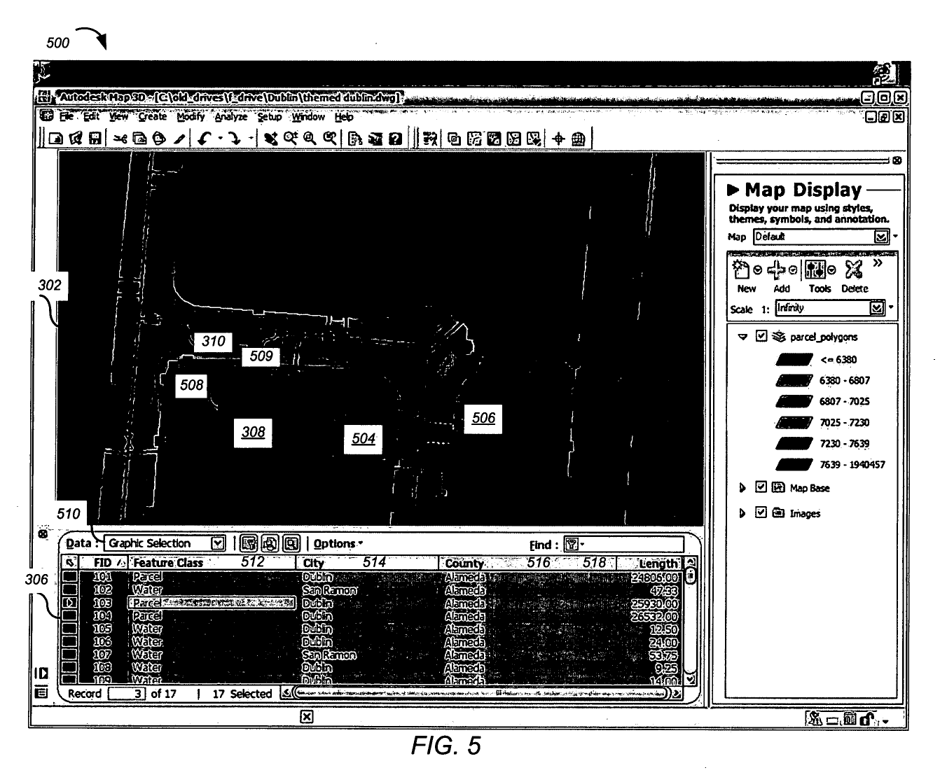

FIG. 5 shows a graphics window 500 following the selection of an original graphic selection set from the selection region 402 of FIG. 4. The graphics window 500 includes the map object 302. The map object 302 includes selection indicators identifying the elements included within the selection region 402. In one implementation, the selected elements include only elements that were wholly contained within the selection region 402. In an alternative implementation, the selected elements include all the elements within the selection region 402, in whole or in part.

The elements within the selected set of elements are visually differentiated in the image of the map object 302. For example, selected parcel elements (e.g., parcels 308, 504, and 506) can include a visual effect, e.g., a different color, style of shading, or highlighting. Additionally, the boundaries of the selected parcels includes markers (e.g., marker 508) demarcating the boundary and center of the selected parcels. Similarly, water lines (e.g., water line 310) within the selected set of elements can include a changed visual representation including different color, shading, or highlighting to distinguish the selected water line elements from the unselected elements. The selected water line elements also include selection markers (e.g., marker 509) indicating the boundaries of individual water line segments.

Additionally, the data grid 306 has now been populated with data associated with the selected set of elements. The data grid 306 includes a number of columns and rows that include the data associated with the displayed elements. A data view drop down menu 510 has “graphic selection” indicated so that the data grid presents all elements from the set of selected elements. In this implementation, the column data in the data grid 306 includes a feature class 512. The feature class 512 indicates the class of each element in the data grid. For example, the displayed classes shown in data grid 306 include a parcel class and a water class. Other classes can also be displayed depending on the types of elements within the selection set selected by the user.

In this implementation, the data grid 306 also displays element parameters common to elements of each displayed class. For example, data grid 306 includes a city 514, county 516, and length 518 data for each element of the selection set since these properties are common to both parcel and water line elements.

A first subselection of elements from the set of selected elements is received (step 208). For example, in one implementation, the user can manually select specific elements from the selected elements in the displayed graphical object or data grid. Alternatively, the user can select a particular element class from the data grid 306 as the subselection. The subselection of elements can be made without modifying or losing the previously generated original graphic selection set of elements.

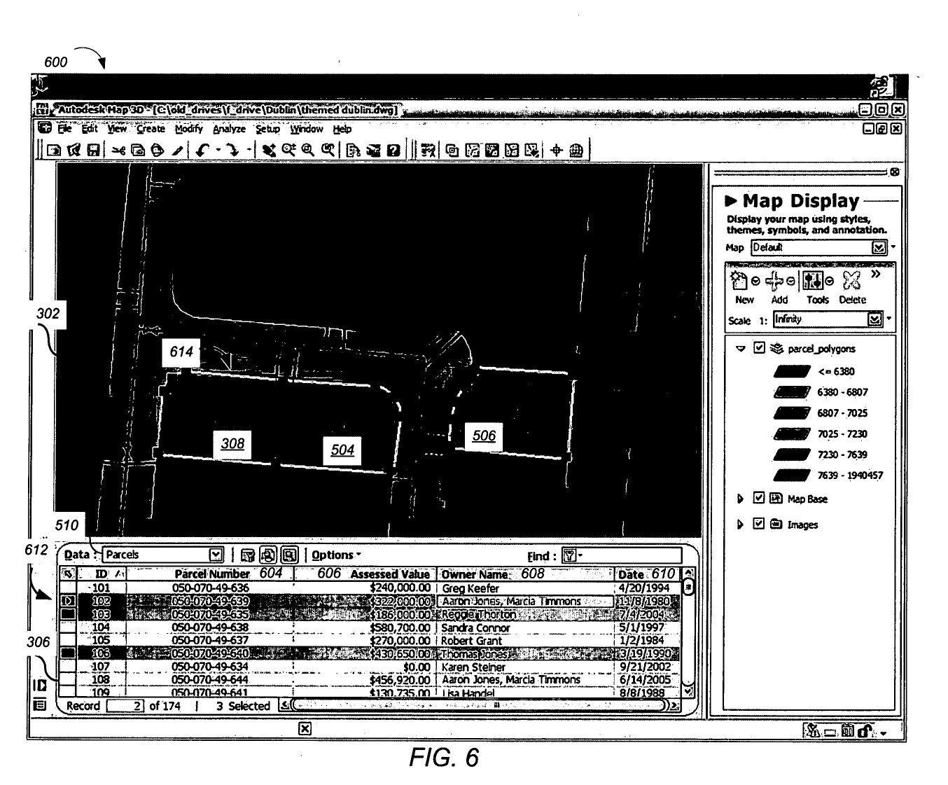

The first subselection of elements is displayed (step 210). FIG. 6 shows a graphics window 600. Graphics window 600 includes an image of the map object 302 in which a particular class of elements has been subselected. Specifically, in the map object 302, only the parcel elements 308, 504, and 506 are shown as subselected. The parcels are visual differentiated in the map object 302 (e.g., by highlighting 614). The other elements of the selected set of elements are not distinguished from the rest of the unselected elements in the map object 302.

The data grid 306 also illustrates the parcel subselection. The data view drop down menu 510 now specifies a “parcels” class instead of the “graphics selection” shown in FIG. 5, and the data grid 306 only shows parcel elements. The parcels of the subselection 612 are highlighted in the data grid 306. The column information in the data grid 306 also includes parcel specific information. The data grid identifies parcel numbers 604, assessed value 606, owner names 608, and date information 610. Other parameters associated with the elements can be displayed. In one implementation, a user can select which element parameters to display in the data grid 306.

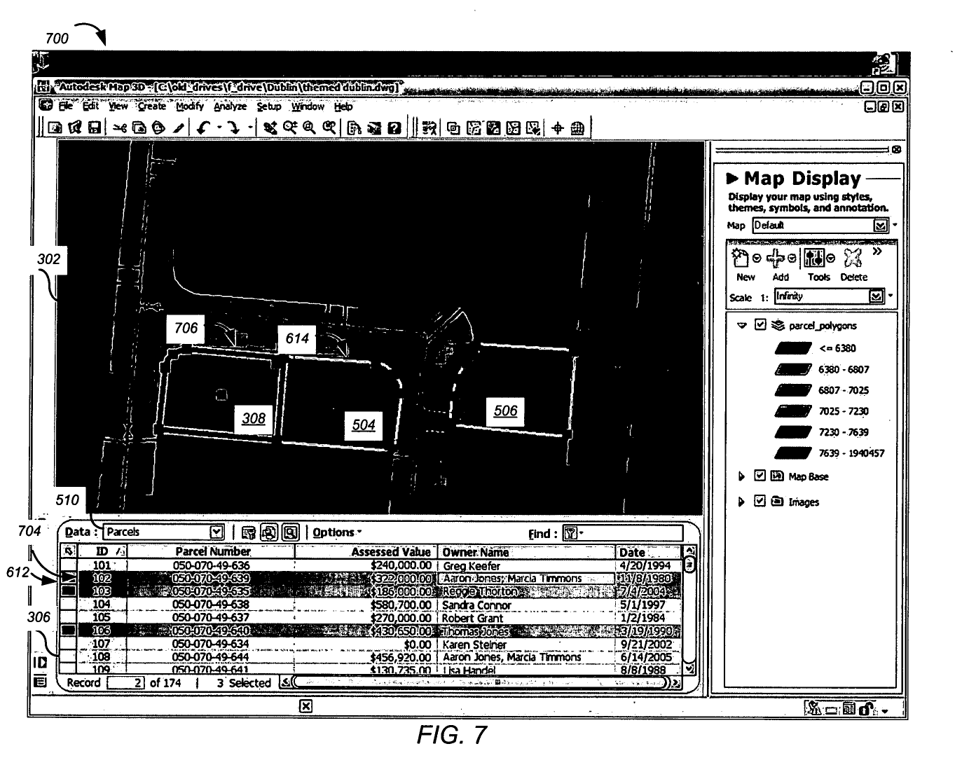

The user can identify a particular element of the subselection of elements (step 212). FIG. 7 shows a graphics window 700. Graphics window 700 includes an image of the map object 302 in which a single element of the subselection has been selected. The data grid 306 includes an arrow indicator 704 showing the selection of a parcel 308 in the subselection of elements. In the map object 302, the identified element 308 includes highlighting 706. The displayed highlighting can be in addition to the highlighting 614 for all of the elements of the subselection, visually differentiating the individually selected element from the subselection of elements. In one implementation, the particular element of the subselection can be selected directly from the map object 302. In another implementation, the user can use the data grid 306 to make the individual selection (e.g., by selecting a particular row in the data grid 306).

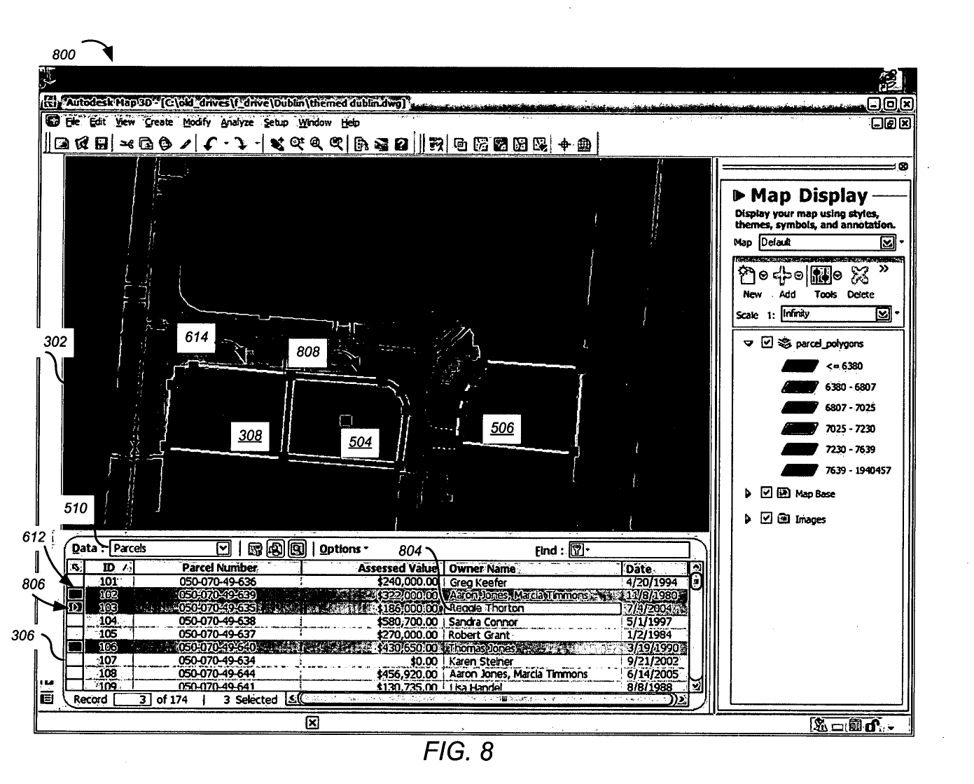

The user can switch the individually selected element of the subselection to a different element. FIG. 8 shows a graphics window 800. The graphics window 800 includes an image of the map object 302 in which a different element of the subselection is individually selected. In map object 302, the selected element of the subselection has been changed to parcel 504. Parcel 504 now has extra highlighting 808 in addition to the subselection highlighting 614. Additionally, the row corresponding to parcel 504 in the data grid has the arrow pointer 806 indicating selection of parcel 504 from the subselection of elements 612.

In one implementation, the user can edit an element selected from the subselection (step 214). For example, the user can modify one or more displayed parameters for elements in the subselection of elements. For example, in one implementation, the user can use an input device (e.g., a mouse) to select a particular cell within the data grid in order to edit the parameter data associated with the selected cell. In FIG. 8, cell 804 of the selected parcel 504 has been selected. The cell corresponds with the owner of the parcel 504. The user can modify the data associated with the cell 804, for example, to change the name of the owner. The modified parameters can be stored such that future use of the parcel 504 includes the changed parameter.

A second subselection from the selected set of elements can be received from the user (step 216). The user can make a different subselection of elements from the original selected set of elements. Thus, the original set of selected elements identified, for example, using the selection region 402 of FIG. 4, is retained so that other subselections can be made from the same set of elements after a first subselection has already been made. Subsequent subselections can include elements common to previous subselections or can be independent of previous subselections. Elements of the new subselection are visually differentiated in the map object, while the elements of the previous subselection are not.

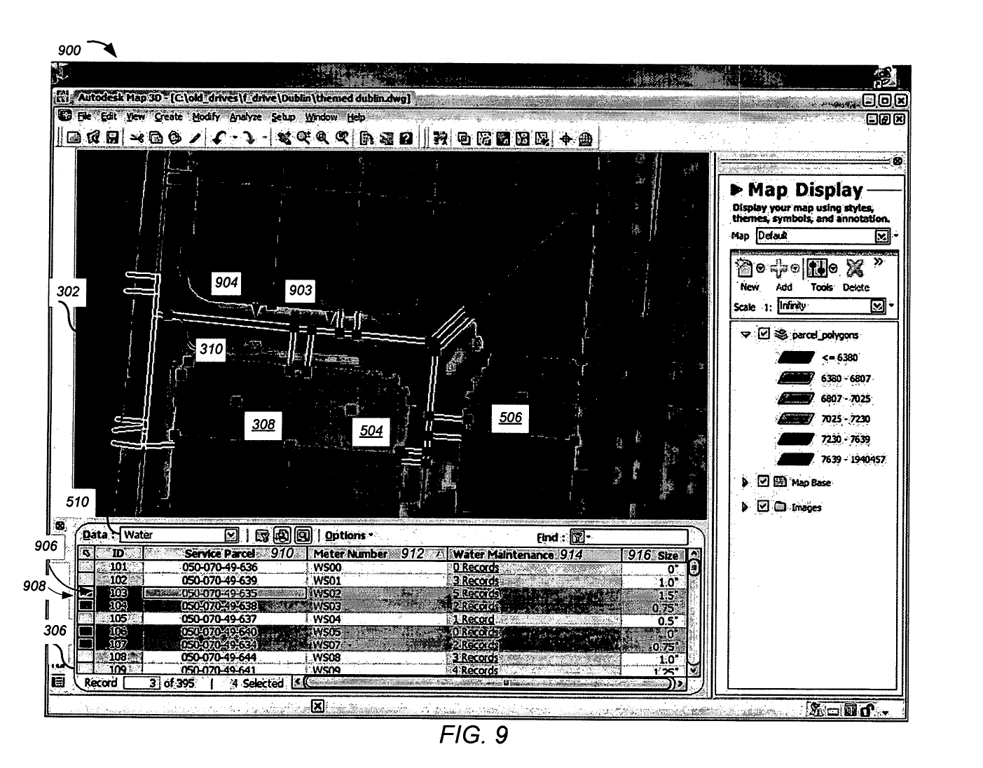

The second subselection can be displayed (step 218). FIG. 9 shows a graphics window 900. The graphics window 900 includes an image of the map object 302 illustrating a subselection of a different class of elements from the selected set of elements. Map object 302 illustrates a subselection of elements in the selection having a water class.

For example, a user can change the class of the subselection using the data view drop down menu 510 to select the water class. The data grid 306 then displays the elements of the map object 302 having the water parameter. The water line elements within the set of selected elements are highlighted 906 in the data grid. Additionally, highlight 903 indicates the water elements (e.g., water line 310) within the set of selected elements. Note that the parcel elements (e.g., parcels 308, 502, and 504) from the previous subselection are no longer highlighted because they are not included in the new subselection of elements.

In one implementation, the data grid 306 provides parameter data specifically for the second subselection, i.e., the water class elements. For example, the columns for the water elements include a service parcel 910, meter number 912, water maintenance records 914, and size 916 parameters. Additionally, a user can use the data in a parameter to access other information. For example, the water maintenance records 914 include element cells having hyperlinks 918. The hyperlinks 918, upon selection, can provide the user with additional information, for example, further details of water maintenance of the particular water line element such as the field technician, the action taken, and the project status. In one implementation, selecting a hyperlink 918 opens the associated data in the data grid 306. In an alternative implementation, selecting a hyperlink 918 opens the associated data in a separate window.

Additionally, as with the parcel subselection described above, a particular water element can be selected from the subselection of elements. In FIG. 9, the water line 310 is selected. The selection of water line 310 can be indicated, for example, by additional highlighting 904 as well as a marker 908 in the data grid 306.

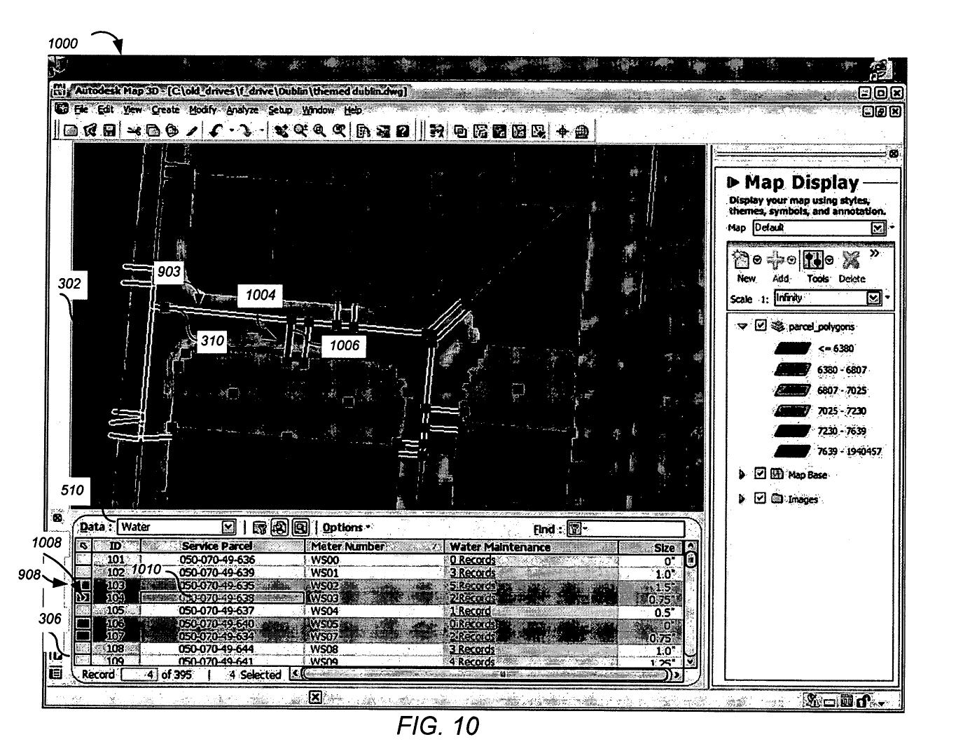

Furthermore, the user can switch the individual selection of the water element. For example, in FIG. 10, a graphics window is shown where the map object 302 has a different water element selected. In map object 302, water line 1006 is selected from the subselection of water elements. Water line 1006 is shown having highlighting 1004 in addition to subselection highlighting 903. Additionally, the data grid 306 indicates the particular selection of the water line element 1006 by marking entry 1008 of the highlighted subselection of water elements 906.

The user can also edit parameters of the water elements. For example, cell 1010 of water line 1006 is selected such that the user can change the service parcel 910 associated with the water line 1006.

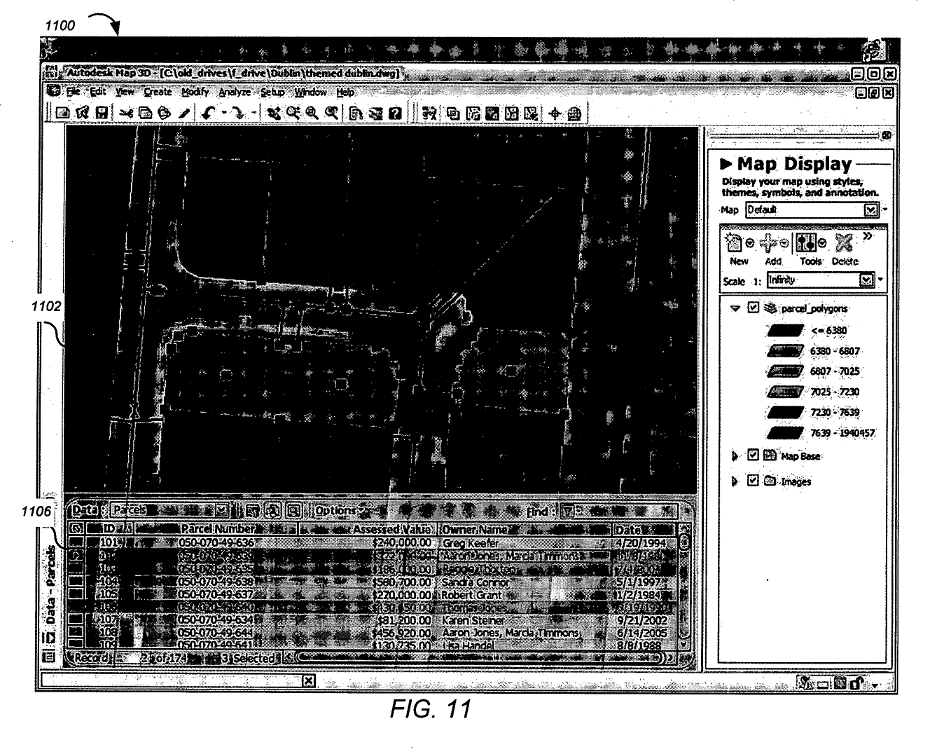

The data grid has been described above as a separate frame object in the graphics window (e.g., data grid 306 in FIG. 4). However, other implementations of the data grid are possible. For example, the data grid can also be a transparent overlay component on the map object. FIG. 11 illustrates an editing window 1100. The editing window 1100 includes a map object 1102. The editing window 1100 also includes a transparent overlay data grid 1106. In one implementation, the transparent data grid 1106 is movable such that it can be positioned at different positions on the map object 1102.

An engine, as the term is used throughout this application, can be a piece of hardware that encapsulates a function, can be firmware or can be a software application. An engine can perform one or more functions, and one piece of hardware, firmware or software can perform the functions of more than one of the engines described herein. Similarly, more than one piece of hardware, firmware and/or software can be used to perform the function of a single engine described herein.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device, media, or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

A number of embodiments of the invention have been described. Nevertheless, it will be understood that various modifications may be made without departing from the spirit and scope of the invention. For example, particular visual representations are discussed above with respect to visually identifying a set of selected graphical elements and subselections of graphical elements. However, any type of visual or non-visual effect can be used which allows the user to differentiate between a selection set of graphical elements and a subselection of graphical elements. Accordingly, other embodiments are within the scope of the following claims.

What is claimed is:

1. A computer-implemented method for graphical subselection, comprising:
presenting an image to a user, the image including an original graphic selection set of graphical elements;
receiving a first user input identifying a first subselection of elements in the original graphic selection set;
visually differentiating the first subselection of elements in the image presented to the user;
receiving a second user input identifying a second subselection of elements in the original graphic selection set, where the second subselection of elements is different from the first subselection of elements; and
visually differentiating the second subselection of elements in the image presented to the user.

2. The method of claim 1, where presenting an image to a user including an original graphic selection set of graphical elements comprises:
presenting an image to a user including a plurality of graphical elements; and
receiving a user input selecting the original graphic selection set of graphical elements.

3. The method of claim 2, where receiving a user input selecting the original graphic selection set comprises:
receiving a user input generating a selection region imposed on the image, where the original graphic selection set comprises substantially all of the graphical elements included within the selection region.

4. The method of claim 2, where selecting the original graphic selection set of graphical elements includes selecting graphical elements from a plurality of layers in the image.

5. The method of claim 4, where graphical elements belonging to a single class are located in a single layer in the image.

6. The method of claim 4, where the selection of graphical elements from a plurality of layers occurs substantially simultaneously.

7. The method of claim 1, further comprising:
visually differentiating the graphical elements of the first subselection of elements in the image.

8. The method of claim 7, where visually differentiating includes highlighting the graphical elements of the first subselection of elements in the image.

9. The method of claim 1, further comprising:
displaying a data grid including data associated with the graphical elements included in the original graphic selection set of graphical elements.

10. The method of claim 9, further comprising:
visually differentiating the first subselection of elements in the displayed data grid.

11. The method of claim 9, further comprising:
visually differentiating the second subselection of elements in the displayed data grid.

12. The method of claim 10, where visually differentiating the first subselection of elements in the displayed data grid includes highlighting data included in the data grid that is associated with the elements included in the first subselection of elements.

13. The method of claim 11, where visually differentiating the second subselection of elements in the displayed data grid includes highlighting data included in the data grid that is associated with the elements included in the second subselection of elements.

14. The method of claim 1, further comprising:
selecting a single element of the first subselection of elements; and
editing a value for a parameter associated with the selected element.

15. The method of claim 14, further comprising:
applying an additional visual effect to identify the selected single element of the subselection of elements.

16. The method of claim 1, where the first user input selecting a first subselection of elements includes selecting a particular class of elements from the original graphic selection set.

17. The method of claim 16, where selecting a particular class of elements includes directly selecting an element of a particular class from the original graphic selection set of elements in the image.

18. The method of claim 16, where selecting a particular class of elements includes selecting a class from a menu.

19. An apparatus for graphical subselection, comprising:
a graphics engine configured to display an image, the image including a plurality of graphical elements;
a selection engine configured to select an original graphic selection set of graphical elements;
a sub-selection engine configured to select a subselection of elements in the original graphic selection set according to a received user input; and
a display engine configured to display the image including the selected subselection of elements,
wherein the selection engine stores the original graphic selection set of graphical elements for use in subsequent element subselections.

20. The apparatus of claim 19, where the display engine displays data associated with the original graphic selection set in a data grid.

21. The apparatus of claim 20, where the user selects a subselection of elements using the data grid.

22. The apparatus of claim 21, where the data grid is populated with data associated with the subselection of elements.

23. The apparatus of claim 19, where the display engine visually differentiates graphical elements in the displayed image to identify the original graphic selection set of graphical elements.

24. The apparatus of claim 19, where the display engine visually differentiates the graphical elements of the subselection in the displayed image to identify subselection of elements.

25. The apparatus of claim 19, where the selection engine is further configured to select an individual graphical element of the subselection of elements.

26. The apparatus of claim 25, further comprising:
an editing engine configured to modify data associated with a selected graphical element from the subselection of elements.
